(19) United States
(12) Patent Application Publication
(10) Pub. No.: US 2021/0140164 A1
(43) Pub. Date: May 13, 2021

(54) Form for a Plastic Lined Concrete Septic System Distribution Box

(71) Applicant: Brian Brown, Weare, NH (US)

(72) Inventor: Brian Brown, Weare, NH (US)

(21) Appl. No.: 16/616,575

(22) PCT Filed: Jun. 8, 2017
(86) PCT No.: PCT/US17/36486

§ 371 Date: Nov. 25, 2019

(51) Int. Cl. E03F 5/02; B29D 99/00; C02F 1/00

(52) U.S. Cl. CPC E03F 5/025; C02F 1/006; B29D 99/00; E03F 5/024

(57) ABSTRACT

A form for a plastic lined septic system distribution box is configured to receive a fill material. The form includes a jacket, a plastic core, a plastic inlet ring, and a plastic outlet ring. The jacket defines an exterior wall and exterior floor of the distribution box. The core defines an interior wall interior floor of the distribution box. The inlet portal ring and outlet portal ring extend between the core interior wall and the jacket exterior wall. The core and jacket are arranged to leave a space therebetween to receive the fill material, and the core is configured to serve as the interior wall and interior floor of the distribution box and to line the fill material for the distribution box during use.

### FIELD OF THE INVENTION

The present invention relates to septic systems, and more particularly, is related to a distribution box for a septic system.

### BACKGROUND OF THE INVENTION

A septic system distribution box (“D-box”) is structured as a chamber with a solid floor, walls with inlet/outlet ports, and a removable ceiling. The D-box has a single inlet to receive an inflow of septic fluids and two or more outputs for distributing an outflow of the fluids, for example, to a leeching field.

Previously, D-boxes have been made of concrete (which may break down over time due to exposure to caustic fluids), or plastic (which are light and may be displaced as a result of temperature changes, for example frost heaves). An exemplary simplified prior art D-box 100 is shown from a perspective top view in FIG. 1A and a perspective side view in FIG. 1B. The D-box 100 includes a floor 130 and walls 140, 141, 142, 143. Fluid enters the D-box 100 via an inlet portal 110, for example through an inlet pipe (not shown) and exits via outlet portals 120a, 120b, 120c, 120d, 120e, through outlet pipes (not shown). A lid 150 attaches to one or more of the walls 140, 141, 142, 143, for example with screws or other fasteners for a plastic D-box, or using butyl mastic to seal a concrete lid to a concrete D-box.

The prior art concrete and/or plastic D-boxes 100 may be produced using a re-usable steel form or plastic injection molding. Therefore, there is a need in the industry to address one or more of these shortcomings.

### SUMMARY OF THE INVENTION

Embodiments of the present invention provide a form for a plastic lined concrete septic system distribution box. Briefly described, the present invention is directed to a form for a plastic lined septic system distribution box configured to receive a fill material. The form includes a jacket, a plastic core, a plastic inlet ring, and a plastic outlet ring. The jacket defines an exterior wall and exterior floor of the distribution box. The core defines an interior wall interior floor of the distribution box. The inlet portal ring and outlet portal ring extend between the core interior wall and the jacket exterior wall. The core and jacket are arranged to leave a space therebetween to receive the fill material, and the core is configured to serve as the interior wall and interior floor of the distribution box and to line the fill material for the distribution box during use.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1A is a schematic diagram showing an exemplary prior art D-box from a perspective top view.

FIG. 1B is a schematic diagram showing the exemplary prior art D-box of FIG. 1A and cover from a perspective side view.

FIG. 2A is a schematic diagram of a first embodiment of a distribution box.

FIG. 2B is a schematic diagram showing a cutaway view of the distribution box of FIG. 2A.

FIG. 2C is a schematic diagram showing an exploded view of the distribution box of FIG. 2A.

FIG. 2D is a schematic diagram showing an exploded view of the distribution box of FIG. 2A with the portal rings integral with the core.

FIG. 2E is a schematic diagram showing a third embodiment of a distribution box with an integral core, jacket, and portal rings.

FIG. 3A is a schematic diagram of a variation of the first embodiment of a distribution box of FIG. 2A where the jacket wall rises above the core wall.

FIG. 3B is a schematic diagram showing a cutaway view of the distribution box of FIG. 3A.

FIG. 4 is a schematic diagram showing first example grade ring for the distribution box of FIG. 2A.

FIG. 5 is a schematic diagram showing second example grade ring for the distribution box of FIG. 3A.

FIG. 6 is a schematic diagram showing an exemplary floor configuration for the distribution box of FIG. 2A.

FIG. 7A is a schematic diagram showing an alternative embodiment of a distribution box having a circular exterior profile and a hexagonal interior profile.

FIG. 7B is a schematic diagram showing an alternative embodiment of a distribution box having a hexagonal exterior profile and a hexagonal interior profile.

FIG. 8 is a schematic diagram showing a second embodiment of a distribution box having an unlined exterior.

FIG. 9 is a schematic diagram showing the distribution box of FIG. 8 with a riser.

FIG. 10 is a schematic diagram showing the distribution box of FIG. 9 with a cover.

FIG. 11 is a schematic diagram showing a form for producing the distribution box of FIG. 8 from a first viewpoint.

FIG. 12 is a schematic diagram showing a form for producing the distribution box of FIG. 8 from a second viewpoint.

FIG. 13 is a flowchart showing a method of forming a single use form for a plastic lined concrete septic system distribution box configured to receive a fill material.

### DETAILED DESCRIPTION

The following definitions are useful for interpreting terms applied to features of the embodiments disclosed herein, and are meant only to define elements within the disclosure.

As used within this disclosure, a “portal” generally refers to an aperture extending between the jacket wall or ceiling and core wall or ceiling of a D-box. The structural portion of the form used to form a portal is referred to as a “ring.” The ring may be open, or it may be sealed, for example with a panel, so the portal may accommodate different sized pipes. For example, the panel may be formed with thin portions to facilitating removing a portion of the panel to accommodate one or more standard pipe sizes. While portals are generally depicted herein as having a circular profile, the embodiments may incorporate portals having other shapes, for example, but not limited to ovals, ellipses, polygons, and others.

As used within this disclosure, “substantially” means “very nearly,” or to within normal manufacturing tolerances. For example, a material described as substantially rigid may exhibit some degree of flexibility, but provide sufficient rigidity to perform its intended purpose.

As used within this disclosure, a “setting fill” or a “settable fill” refers to a pourable substance, for example, a loose granular material or liquid, that becomes structurally rigid after it is poured, for example, concrete or a liquid resin. The settable fill is generally suitable for use in a form, where upon setting the fill assumes a set shape according to the shape of the form. In general, fill surfaces in the drawings are depicted by showing small round circles (indicating stones in the fill).

Reference will now be made in detail to embodiments of the present invention, examples of which are illustrated in the accompanying drawings. Wherever possible, the same reference numbers are used in the drawings and the description to refer to the same or like parts.

Exemplary embodiments of the present invention are directed to a plastic lined concrete D-box. Under a first embodiment D-box itself begins as a plastic D-box form to be filled with concrete. After the form is filled, for example, with concrete, the plastic D-box form is incorporated into the finished D-box itself, serving to line the concrete. Therefore, under the first embodiment the structure functions both as a single use concrete form for a D-box and as a plastic lining for the interior and exterior of the concrete D-box.

FIG. 2A is a schematic diagram of the first embodiment of a D-box 200. FIG. 2B shows a cutaway view of the D-box 200, and FIG. 2C shows an exploded view of the D-box form 200 before a fill is added. The D-box 200 is formed from two main portions, a core 245, and a jacket 240 which is configured to receive the core 245. The core 245 and the jacket 240 are formed of a water resistant and substantially structurally rigid material such as plastic, for example, but not limited to PVC, polyethylene, and/or fiberglass. The material used for core 245 and the jacket 240 is preferably sufficiently flexible to accommodate and withstand stresses from expansion and/or contraction of the fill material 250, for example, due to changes in temperature. The material used for the core 245 and the jacket 240 may have a thickness in the range of 1/16 inches to ⅝ inches or more.

The core 245 and the jacket 240 may be formed from sheets of material that may be cut, bent, and/or welded together, may be formed by injection molding, or may be formed by other means familiar to persons having ordinary skill in the art.

As used within this disclosure, the term “D-box” generally refers to at least the jacket 240 and the core 245 with a fill material disposed between the jacket 240 and the core 245, while the term “form” generally refers to the jacket 240 and the core 245 without a fill material disposed therebetween. Similarly, language describing portions of the D-box 200, for example walls 270, 275, may be changed when referring to portions of the form 200.

A fill material 250 is poured between the jacket 240 and core 245 to form the walls 270 and floor 230 of the D-box. The fill material 250 may be a setting material, for example concrete, or a loose fill material, for example sand or soil. The core 245 and the jacket 240 may be arranged to leave a space therebetween to receive the fill material 250, such that the core 245 and the jacket 240 are separated throughout by at least a minimum wall width, for example, a minimum wall width in the range of up to 1 to 4 inches or more. The core 245 is configured to serve as an interior wall 275 and interior floor 235 of the D-box 200 to line the fill material 250 for the D-box 200 during use. Similarly, the jacket 240 is configured to serve as an exterior wall 270 and an exterior floor 230 of the D-box 200 to line the fill material 250 for the D-box 200 during use.

While the form 200 is preferably used with the fill material 250 between the jacket 240 and the core 245, the form 200 may have sufficient structural integrity to hold its physical form without the fill material 250. Using a loose fill material 250 may be desirable in some circumstances, for example, since an unfilled form 200 may be more easily transported to the use site than a filled D-box 200, and the form 200 may be filled at the use site using either a loose fill (non-setting fill) or a settable fill.

The jacket 240 may typically have a diameter on the order of 12 inches to 36 inches or more, and the space between the jacket and the core may be for example, in the range of 1-4 inches, resulting in the wall portion 270 of the D-box 200 having a thickness in the range of 1-4 inches, plus the thickness of the core 245 and/or the jacket 240. The floor 230 of the D-box 200 may have the same thickness as the wall portion 270, or may be thicker or thinner. In general, a thicker wall 270 or floor 230 may be needed to accommodate a coarser fill material 250, for example, cement with larger stones may not spread evenly through the form 200 if the wall portion 270 or floor 230 is narrow with respect to the stone size.

The height of the jacket wall 270 may be on the order of, for example, 8-24 inches or more. The top of the jacket wall 270 may be even with the top of the core wall 275, as shown in FIGS. 2A-2B. In an alternative embodiment D-box 300, the top of the jacket wall 270 may be configured to extend above the top of the core wall 275, as shown in FIGS. 3A-B. All other features of the alternative embodiment D-box 300 are substantially similar to the first embodiment D-box 200. The fill material 250 may be filled up to the top of the lower of the jacket wall 270 and the core wall 275, although it may be desirable for a lower level of fill material 250, so that the jacket wall 270 and/or the core wall 275 extends above the fill material 250. In another alternative embodiment (not shown) the top of the core wall 275 may be configured to extend above the top of the jacket wall 270.

Both the jacket wall 270 and the core wall 275 have at least one inlet portal 210 configured to receive an inlet portal ring 215. The inlet portal ring 215 may be attached and/or sealed to the jacket wall 270 and/or the core wall 275 to define the inlet portal 210.

The inlet portal ring 215 may be attached and/or sealed to the jacket wall 270 and/or the core wall 275 by welding, bolting, rotational threading, or other means familiar to persons having ordinary skill in the art.

Similarly, both the jacket wall 270 and the core wall 275 may have one or more outlet portals 220a, 220b, 220c, 220d, 220e, passing through the jacket wall 270 and the core wall 275, each portal configured to receive a respective outlet portal ring 225a, 225b, 225c, 225d, 225e. The outlet portal rings 225a, 225b, 225c, 225d, 225e may be sealed to the jacket wall 270 and/or the core wall 275 in a manner similar to the inlet portal ring 215 described above. The inlet portal ring 215 and outlet portal rings 225a, 225b, 225c, 225d, 225e may preferably be formed of a material, for example plastic or rubber, that resists corrosion by the fluid passing through the D-box 200. For example, the material of the portal rings 215, 225a, 225b, 225c, 225d, 225e may be a similar material as the core 245 and jacket 240. While the first embodiment is depicted as having five outlet portals, 220a, 220b, 220c, 220d, 220e, alternative embodiments may have more or fewer outlet portals. The portal rings 215, 225a, 225b, 225c, 225d, 225e (referred to hereafter as the portal rings 215, 225) may be cast into the D-box 200, for example, by being in place when a settable fill is added to the form 200, or the portal rings 215, 225 may be installed after the settable fill material 250 has cured.

One or more of the portal rings 215, 225 may be formed of two or more pieces, for example, a mandrel that may be attached to the jacket 240 at a first end, and attached to a seal pipe at a second end, where the seal pipe attaches to the core 245.

Alternatively , as shown in FIG. 2D , the portal rings 215, 225 may be formed integrally with the core 245, so that the portal rings 215, 225 extend outward from the exterior surface of the core 245 to be flush with and/or sealed against the interior surface of the jacket 240. As shown in FIG. 2D, the jacket 240 may be formed such that the inlet portal 210 and outlet portals 220 are not formed through the jacket 240, so that an end user may choose the portal configuration by only forming portals 210, 220 they desire by removing portions of the jacket 240 corresponding to the location of the portal rings 215, 225 on the core 245.

In another alternative embodiment (not shown), the portal rings 215, 225 may be formed integrally with the jacket 240, so that the portal rings 215, 225 extend inward from the interior surface of the jacket 240 to be flush with and/or sealed against the exterior surface of the core 245. The core 245 may be formed such that the inlet portal 210 and outlet portals 220 are not formed through the core 245, so that an end user may choose the portal configuration by only forming portals 210, 220 they desire by removing portions of the core 245 corresponding to the location of the portal rings 215, 225 on the jacket 240.

The portal rings 215, 225 have been generally depicted as circular, but may be other shapes, for example oblong circles, ovals, ellipses, polygons, or irregular shapes to accommodate attachment to pumps or other devices. The portal rings 215, 225 may be sized to accommodate attachment to pipe ranging from up to 1 inch to six inches or more.

The inlet portal 210 is generally configured to have a center higher above the core floor 235 than a center of the outlet portals 220, thereby assisting flow of fluid from the inlet portal 210 through the D-box 200 to the outlet portals 220. For example, the inlet portal may begin 4-8 inches above the floor, while the outlet portals 220 may begin 2-4 inches above the floor 235.

While FIGS. 2A-2C depict the core wall 275 as being substantially parallel to the jacket wall 270, in alternative embodiments the core wall 275 may taper inward or taper outward with respect to the jacket wall 270. Similarly, the jacket wall 270 may taper inward or outward with respect to the core wall, such that the distance between the core wall 275 and the jacket wall 270 varies according to height with respect to the core floor 235 and/or the jacket floor 230.

The core wall 275 may include one or more core posts 265 to provide structural support to the core wall 275. The core posts 265 may be disposed on the interior of the core wall 275, the exterior of the core wall 275, or both. Similarly, the jacket wall 270 may include one or more jacket posts 260 to provide structural support to the core wall 275. The jacket posts 260 may be disposed on the interior of the jacket wall 270, the exterior of the jacket wall 270, or both.

The posts 260, 265 may be used in conjunction with one or more spacer brackets (not shown) each spanning between a core post 265 and a jacket post 260 to maintain the position of the core 245 in relation with the jacket 240. Similarly, one or more spacer brackets may be used to maintain the spacing between the core floor 235 and the jacket floor 230, for example, to prevent the core 245 from floating with respect to the jacket 240 when the fill material 250 is added to the form 200.

Other structural elements may optionally be used to reinforce the jacket and/or core so that the jacket 240 and/or core 245 retain their shapes when exposed to deforming forces, for example forces exerted by the fill material 250. For example, beams (not shown) may be configured to extend along the core wall 275 and/or the jacket wall 270 between the posts 260, 265. Similarly, reinforcing rings (not shown) may be positioned to encircle the inlet portal 210 and/or the outlet portals 220 to provide structural support.

Either end of the post 260, 265 may include a threaded bore (not shown) to facilitate, for example, a screw, bolt, or other fastener, for example used to secure a lid, riser, or grade (extension) ring to the D-box 200. The posts 260, 265 and or spacer brackets may be formed of the same material as the core 245 and jacket 240, or may be formed of a more rigid material, for example, wood or metal.

The core 245 is configured to serve as a portion of the form 200, but also as a seal for the finished D-box, for example, to seal the fill material 250, protecting the interior of the D-box from corrosion by, for example, salts or chemicals present in the D-box 200 during use in its intended functionality, namely distributing and dispersing fluids to a leeching field. Therefore, after serving as a portion of the form to produce the D-box 200, the core 245 may serve a functionality similar to a sealing interior liner for a traditional D-box 100 (FIGS. 1A, 1B). Similarly, the inlet portal ring 215 and outlet portal rings 225a, 225b, 225c, 225d, 225e serve as a barrier preventing fluids from contacting the fill material 250 while the D-box 200 is being used for its intended functionality. It should be noted that unlike a traditional seal, for example, for a concrete vessel, the form 200 contributes to the structural integrity of the D-box 200, whereas a typical seal merely provides a non-structural barrier to seal the fill material 250 against foreign substances, for example, fluids.

A shown by FIG. 4, the D-box 200 may further include additional portions, for example a riser or a grade ring 400 used to extend and/or insulate the walls 270, 275 of the D-box 200. The grade ring 400 may be formed of any suitable material, for example plastic or steel, and may be attached to the form 200 before the fill material 250 is added, or may be attached to the D-box 200 after the fill material 250 is added. The grade ring 400 may be an open or closed ring, and may be configured to connect to additional fixtures, for example, a cover 1000, as shown in FIG. 10. The grade ring 400 may be attached to the D-box 200 by various means, for example, with adhesives, welding, or fasteners, or may be secured to the D-box 200 by fill material 250 after setting. As shown by FIG. 4, the grade ring 400 may have a threaded male portion 410a configured to be received by a threaded female portion 410b on the D-box via a rotational (screw) motion. For example, the threaded female portion 410b may be implemented on the interior wall 275 of the D-box 200.

For the D-box 300 of FIG. 3A, the threaded female portion 410b may be implemented on an interior surface of the exterior wall 270 of the D-box 300, as also shown by FIG. 5. FIGS. 4 and 5 shows the riser attached to a top portion of the D-box 200, 300, however, in alternative embodiments the grade ring 400 or other riser may be attached at a base portion of the D-box 200, 300 (not shown).

As shown by FIG. 6, the floor 235 of the D-box may include additional features, for example, a baffle 610 or beam extending upward from the floor 235 and partially or entirely partitioning a section of the floor 235 to at least partially separate a first portion of the floor 235 near the inlet portal 210 from second portion of the floor 235 near the outlet portals 220. For example, it may be desirable to include a baffle 610 extending upward from the floor 235. One or more baffles 610 on the floor 235 of the D-box may be formed, for example, by incorporating corresponding features in the core 245. Similarly, a port or drain (not shown) may be installed in the floor 235 by installing a plug extending between the core floor 235 and the jacket floor 230. The D-box 200 may also be configured to accommodate other elements, for example, a drop-in invert channel system.

Under the first embodiment, the form 200 is configured to be filled at an opening between the core and jacket from the top. However, in alternative embodiments, the form 200 may be configured to be filled while in an inverted position, such that the floor 235 of the core 245 is located at the top of the form 200 during filling.

As shown in FIGS. 2A-2C, the shapes of the core 245 and jacket 240 are substantially cylindrical with a round profile, which may facilitate maneuvering of the finished D-box 200, for example by rolling the D-box. However, alternative embodiments may use different shapes for the core 245 and/or jacket 240. For example, FIG. 7A shows an alternative embodiment of a D-box 700 having a substantially circular top exterior profile, with a hexagonal interior profile, while FIG. 7B shows an alternative embodiment of a D-box 750 having a hexagonal top exterior profile and a hexagonal interior profile. Other shapes are possible, for example, square profiles or other polygons, ovals, ellipses, and other curved shapes, as well as shapes formed of a combination of straight and/or curved segments or panels. The interior profile shape may be the same as the exterior profile shape, or the interior profile shape may be different from the exterior profile shape.

As shown by FIGS. 8-12, under a second embodiment 800 a core portion 845 of the D-box itself begins as a single use plastic D-box form to be filled with concrete, while a form jacket 1140 is a reusable structure, for example, a structure formed of steel, plastic, fiberglass, or a structure formed of large diameter PVC pipe (20-28 inch PVC pipe, for example). A floor portion 835 of the core portion 845 may be visible from the top of the jacket 1140 if the D-box 800 is formed in an inverted position to facilitate pouring of the fill material 850, as per FIGS. 11-12. The floor portion 835 may be shaped to produce interior features of the D-box 800, for example an inset portion 1110 to produce a baffle 610 (FIG. 6). After the form 800 is filled with concrete, the plastic D-box core form is incorporated into the finished D-box itself, serving to line the interior of the D-box with concrete, while the exterior of the D-box may be unlined concrete.

The form 800 includes two main portions, a core 845, and a jacket 1140 which is configured to receive the core 845. The core 845 may be formed of a substantially structurally rigid material such as plastic described above regarding the first embodiment.

A fill material 850 is poured between the jacket 1140 and core 845 to form the walls 870 and floor 830 of the D-box 800. The fill material 850 is a setting material such as concrete, as described above regarding the first embodiment.

In general, under the second embodiment the finished D-box 800 may be substantially similar to the first embodiment D-box 200, except the exterior walls 870 are formed by the set fill material 850 instead of the jacket 1140, as the jacket 1140 is removed after manufacturing the D-box, and the jacket 1140 may be re-used to make subsequent D-boxes 800. It should be noted that the jacket 1140, doors 1151, 1152, and hinges 1141, 1142 are generally not incorporated into the finished D-box 800 under the second embodiment.

The core wall 875 may have at least one inlet portal 810 configured to receive an inlet portal ring (not shown). The inlet portal ring may be attached and/or sealed to the core wall 875 to define the inlet portal 810. The inlet portal ring may be attached and/or sealed to the core wall 275 in a similar fashion as described above regarding the first embodiment.

Similarly, the core wall 875 may have one or more outlet portals 820a, 820b, 820c, each configured to receive a respective outlet portal ring 825a, 825b, 825c. The outlet portal rings 825a, 825b, 825c may be sealed to the core wall 875 in a manner similar to the inlet portal ring described above. The inlet portal ring and outlet portal rings 825a-c may be formed of the materials described above regarding the rings for the first embodiment. The portal rings 825a, 825b, 825c may be cast into the D-box 800, for example, by being in place when a settable fill is added to the form 800, or the portal rings 825a, 825b, 825c may be installed after the settable fill material 850 has cured.

One or more of the portal rings 815, 825a, 825b, 225c, 825d, 825e (referred to hereafter as the portal rings 815, 825) may be formed of two or more pieces, for example, a mandrel that may be attached (bolted) to the jacket 440 at a first end, and to a seal pipe at a second end, where the seal pipe may be integral to the core 845. The portal rings 815, 825 may be shaped and sized similarly to the portal rings 215, 225 of the first embodiment.

The jacket 1140 may include a first door 1151 and/or a second door 1152, and one or more sets of hinges 1141, 1142 for opening and closing the first door 1151 and/or the second door 1152 to facilitate manipulating the jacket 1140, in particular to assist in separating the jacket 1140 from the finished D-box after the fill material 850 has set. As with the first embodiment, the second embodiment may accommodate attachments such as a riser 900 and a cover 1000, among other attachments that are configured to attach as described above regarding the first embodiment.

FIGS. 8-10 depict the second embodiment 800 where the profile shapes of the core 845 and jacket 840 are substantially cylindrical with a round profile, while FIGS. 11 and 12 depict an alternative D-Box 800 configuration having a substantially circular top exterior (jacket 840) profile, with a hexagonal interior (core 845) profile. As described above regarding the first embodiment, under the second embodiment other shapes of the D-box 800 are possible, for example, square profiles or other polygons, ovals, ellipses, and other curved shapes, as well as shapes formed of a combination of straight and/or curved segments or panels. The interior profile shape may be the same as the exterior profile shape, or the interior profile shape may be different from the exterior profile shape.

Similar to the first embodiment the floor 235 of the D-box may include additional features (see FIG. 6), for example, a baffle or beam extending upward from the floor 835 and partially or entirely partitioning a section of the floor 835 to at least partially separate a first portion of the floor 835 near the inlet portal 810 from second portion of the floor 835 near the outlet portals 820. For example, it may be desirable to include a baffle 610 extending upward from the floor 235. One or more baffles on the floor 835 of the D-box may be formed, for example, by incorporating corresponding features in the core 845. Similarly, a port or drain (not shown) may be installed in the floor 835 by installing a plug extending from the core floor 835 to a height above the top of the fill material 850. The D-box 800 may also be configured to accommodate other elements, for example, a drop-in invert channel system.

Other variations are also possible. As shown by FIG. 2E, under a third embodiment of a single use form for a distribution box, the jacket 240 core 245, and portal rings 215, 225 may be molded as a single, contiguous unit. FIG. 2E is a schematic diagram showing a third embodiment of a distribution box with an integral core, jacket, and portal rings. In general, other than the integral jacket 240 core 245, and portal rings 215, 225, the third embodiment may be structurally similar to the first embodiment and may accommodate variations described regarding alternative embodiments to the first embodiment.

Under any of the embodiments described above, after filling with fill material 250, 850, the finished D-box 200, 800 may be considered as and function as a one-piece molded D-box having either a lined interior (second embodiment 800) or a lined interior and exterior (first embodiment 200), where the core 245, 845 serves as the interior lining for both the first and second embodiments, and the jacket 240 serves as the exterior lining for the first embodiment. Similarly, the portal rings 215, 225, 815, 825 may serve as the lining for the portals 210, 220, 810, 820.

FIG. 13 is a flowchart 1300 showing a method of forming a form for a plastic lined concrete septic system distribution box configured to receive a fill material. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention. The description of the flowchart 1300 refers to elements shown in FIGS. 2A-2C.

A jacket 240 configured to define an exterior wall 270 and exterior floor 230 of the distribution box 200 is formed, as shown by block 1310. A plastic core 245 having a core interior wall 275 and a core interior floor 235 configured to be disposed within the jacket 240 and to define a shape of the interior wall 275 and interior floor 235 of the distribution box is formed, as shown by block 1320. A plastic inlet portal ring 215 configured to extend between the core interior wall 275 and the jacket wall 270 exterior is formed, as shown by block 1330. A plastic outlet portal ring 225a configured to extend between the core interior wall 275 and the jacket wall 270 interior is formed, as shown by block 1340. The core 245 is arranged inside the jacket 240 to leave a space therebetween to receive the fill material 250, as shown by block 1350.

It will be apparent to those skilled in the art that various modifications and variations can be made to the structure of the present invention without departing from the scope or spirit of the invention. For example, while the description and claims generally use the term “plastic,” the term is intended broadly to refer to water resistant materials with qualities similar to plastic, for example, PVC and fiberglass, among others. In view of the foregoing, it is intended that the present invention cover modifications and variations of this invention provided they fall within the scope of the following claims and their equivalents.

What is claimed is:

1. A form for a plastic lined septic system distribution box configured to receive a fill material, comprising:
a jacket defining an exterior wall and exterior floor of the distribution box;
a plastic core further comprising a core interior wall and a core interior floor configured to be disposed within the jacket and to define a shape of the interior wall and interior floor of the distribution box;
a plastic inlet portal ring configured to extend between the core interior wall and the jacket exterior wall; and
a plastic outlet portal ring configured to extend between the core interior wall and the jacket interior wall,
wherein the core and jacket are arranged to leave a space therebetween to receive the fill material, and the core is configured to serve as the interior wall and interior floor of the distribution box and to line the fill material for the distribution box during use.

2. The form of claim 1, wherein the jacket is formed of plastic and configured to serve as the exterior wall and exterior floor of the distribution box.

3. The form of claim 2, wherein the jacket, core, inlet portal ring and outlet portal ring are integrally formed as a single unit formed from one of the group consisting of plastic, PVC, and fiberglass.

4. The form of claim 1, wherein the fill material comprises a settable fill material.

5. The form of claim 1, wherein a center of the inlet portal ring is located at a first height relative to the interior floor and a center of the outlet portal ring is located at a second height relative to the interior floor, and the first height is greater than the second height.

6. The form of claim 1, further comprising means to attach a grade ring to the distribution box.

7. The form of claim 2, further comprising a plurality of core posts disposed along the core interior wall rising from the interior floor and/or a plurality of jacket posts disposed along the jacket exterior wall.

8. The form of claim 7, further comprising a plurality of removable brackets, each removable bracket extending between a core post of the plurality of core posts and a jacket post of the plurality of jacket posts.

9. The form of claim 1, wherein the core interior floor further comprises a raised baffle portion disposed normal to the inlet portal ring.

10. The form of claim 1, wherein the plastic inlet portal ring and/or the plastic outlet portal ring further comprises a sealing panel.

11. The form of claim 4, further comprising the fill material.

12. The form of claim 4, wherein the jacket is formed of metal and is configured be removed after the fill material has set.

13. A method for forming a form for a plastic lined concrete septic system distribution box configured to receive a fill material, comprising the steps of:
forming a jacket configured to define an exterior wall and exterior floor of the distribution box;
forming a plastic core further comprising a core interior wall and a core interior floor configured to be disposed within the jacket and to define a shape of the interior wall and interior floor of the distribution box;
forming a plastic inlet portal ring configured to extend between the core interior wall and the jacket exterior wall;
forming a plastic outlet portal ring configured to extend between the core interior wall and the jacket interior wall; and
arranging the core inside the jacket to leave a space therebetween to receive the fill material such that the core is configured to serve as the interior wall and interior floor of the distribution box and to line the fill material for the distribution box during use.

14. The method of claim 13, further comprising the step of filling the space between the core and jacket with a fill material.

15. The method of claim 14, further comprising the step of initiating setting of the fill material.

16. A septic system distribution box, comprising:
a plastic jacket defining an exterior wall and exterior floor of the distribution box;
a plastic core further comprising a core interior wall and a core interior floor configured to be disposed within the jacket and to define a shape of the interior wall and interior floor of the distribution box;
a plastic inlet portal ring configured to extend between the core interior wall and the jacket exterior wall;
a plastic outlet portal ring configured to extend between the core interior wall and the jacket interior wall; and
a settable fill material disposed within a space between the core and jacket,
wherein the core and jacket are separated throughout by at least a minimum wall width, and the core is configured to serve as the interior wall and interior floor of the distribution box and to line the fill material for the distribution box during use, and the jacket is configured to serve as the exterior wall and exterior floor of the distribution box during use.

17. A septic system distribution box, comprising:
a concrete exterior wall and exterior floor;
a plastic core further comprising a core interior wall and a core interior floor configured to be disposed within the exterior wall and exterior floor and to define a shape of the interior wall and interior floor of the distribution box;
a plastic inlet portal ring configured to extend through the core interior wall and the exterior wall; and
a plastic outlet portal ring configured to extend through the core interior wall and the exterior wall.
